(19) United States
(12) Patent Application Publication
(10) Pub. No.: US 2020/0036991 A1
(43) Pub. Date: Jan. 30, 2020

(54) DEVICE AND METHOD FOR CODING VIDEO DATA WITH BLOCK SUB-PARTITION AND REFERENCE SAMPLE SELECTION

(71) Applicant: FG Innovation Company Limited, Tuen Mun (HK)

(72) Inventors: HUI-YU JIANG, Hsinchu (TW); YAO-JEN CHANG, Hsinchu (TW)

(21) Appl. No.: 16/523,487

(22) Filed: Jul. 26, 2019

Related U.S. Application Data
(60) Provisional application No. 62/711,243, filed on Jul. 27, 2018.

(51) Int. Cl. H04N 19/44; H04N 19/11; H04N 19/159; H04N 19/119; H04N 19/105; H04N 19/132; H04N 19/176

(52) U.S. Cl. CPC H04N 19/44; H04N 19/11; H04N 19/159; H04N 19/176; H04N 19/105; H04N 19/132; H04N 19/119

(57) ABSTRACT

A method of decoding a bitstream by an electronic device is provided. A block unit is determined from an image frame according to the bitstream. A sub-partition direction of the block unit is determined from a plurality of candidate directions according to the bitstream, and a prediction mode of the block unit is determined from a plurality of candidate mode according to the bitstream. The block unit is partitioned along the sub-partition direction to generate a plurality of sub-block units. A plurality of sample sets each including a plurality of reference samples is determined for the sub-block units and different from each other. Each of the plurality of sub-block units is reconstructed based on a corresponding one of the sample sets according to the prediction mode of the block unit.

### CROSS-REFERENCE TO RELATED APPLICATION(S)

The present application claims the benefit of and priority to a provisional U.S. patent application Ser. No. 62/711,243 filed on Jul. 27, 2018, entitled “Block Division and Reference Sample Selection for Position Dependent Intra Prediction Combination”, with Attorney Docket No. US74587 (hereinafter referred to as “US74587 application”). The disclosure of the US74587 application is hereby incorporated fully by reference into the present application.

### FIELD

The present disclosure generally relates to video coding, and more particularly, to techniques for sub-partitioning a coding block and selecting reference samples for each coding sub-blocks in intra prediction.

### BACKGROUND

Intra prediction is a coding tool for video coding. In a conventional video coding method, an encoder and a decoder only use previously reconstructed pixels in a closest pixel line adjacent to a coding block to generate reference pixels and predictors for predicting or reconstructing the coding block along an orientation.

However, the closest pixel line may include a texture of an object different from other objects in the coding block, and/or signal noise. Although the coding block may be further partitioned into a plurality of coding sub-blocks each having different prediction modes and different closest pixel lines, the number of predicted results may be too high for the encoder to quickly select an appropriate predicted result. Thus, the encoder may need a prediction method for sub-partitioning the block unit into the coding sub-blocks and predicting the coding sub-blocks based on different closest pixel lines according to the same prediction mode to decrease a coding complexity.

### SUMMARY

The present disclosure is directed to a device and method for sub-partitioning a coding block and selecting reference samples for each coding sub-blocks in intra prediction.

In a first aspect of the present application, a method for decoding a bitstream by an electronic device is provided. The method comprises determining a block unit from an image frame according to the bitstream; determining a sub-partition direction of the block unit from a plurality of candidate directions and a prediction mode of the block unit from a plurality of candidate modes according to the bitstream; partitioning the block unit along the sub-partition direction to generate a plurality of sub-block units; determining a sample set including a plurality of reference samples for each of the sub-block units, wherein the sample sets of the sub-block units are different from each other; and reconstructing each of the plurality of sub-block units based on a corresponding one of the sample sets according to the prediction mode of the block unit.

### BRIEF DESCRIPTION OF THE DRAWINGS

Aspects of the exemplary disclosure are best understood from the following detailed description when read with the accompanying figures. Various features are not drawn to scale, dimensions of various features may be arbitrarily increased or reduced for clarity of discussion.

FIG. 1 is a block diagram of an example implementation of a system configured to encode and decode video data, according to an example implementation of the present application.

FIG. 2 is a block diagram of an example implementation of a decoder module of the destination device in the system of FIG. 1, according to an example implementation of the present application.

FIG. 3 illustrates a flowchart in accordance with an example implementation of a prediction method for predicting a plurality of sub-block units based on different reference samples according to the same prediction mode, according to an example implementation of the present application.

FIGS. 4A-4H are schematic illustrations of example implementations of a block unit divided along different candidate directions, according to an example implementation of the present application.

FIG. 5 illustrates a flowchart in accordance with an example implementation of a prediction method for predicting a plurality of sub-block units based on different reference samples according to the same prediction mode, according to an example implementation of the present application.

FIG. 6 illustrates a flowchart in accordance with an example implementation of a prediction method for predicting a plurality of sub-block units based on different reference samples according to the same prediction mode, according to an example implementation of the present application.

FIG. 7 is a schematic illustration of one of a first example implementation of a sub-block unit and a plurality of adjusting samples neighboring the sub-block unit, and a second example implementation of a block unit and the plurality of adjusting samples neighboring the block unit, according to an example implementation of the present application.

FIGS. 8A, 8B and 8C are schematic illustrations of one of a first example implementation of a sub-block unit and different sample regions, and a second example implementation of a block unit and different sample regions, according to an example implementation of the present application.

FIG. 9 illustrates a flowchart in accordance with an example implementation of an adjustment method for adjusting a predicted result based on a block size, according to an example implementation of the present application.

FIG. 10 is a block diagram of an example implementation of an encoder module of a source device in the system of FIG. 1, according to an example implementation of the present application.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features are identified (although, in some examples, not shown) by numerals in the exemplary figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any coding function(s) or algorithm(s) described in the present disclosure may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of applications specific integrated circuitry (ASIC), programmable logic arrays, and/or using one or more digital signal processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to random access memory (RAM), read only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

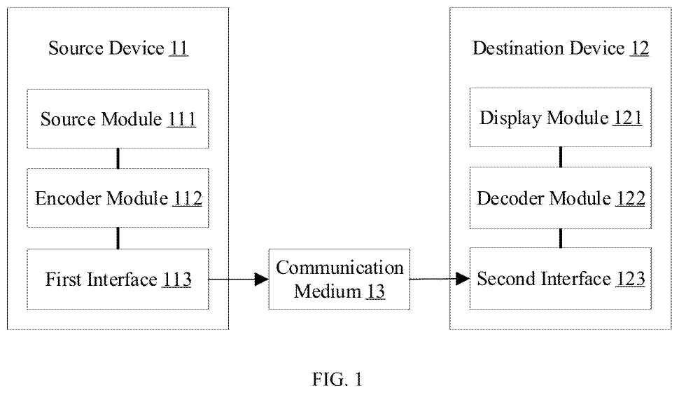

FIG. 1 is a block diagram of an example implementation of a system that may be configured to encode and decode video data according to an example implementation of the present application. In the implementation, the system includes a source device 11, a destination device 12, and a communication medium 13. In at least one implementation, the source device 11 may include any device configured to encode video data and transmit encoded video data to the communication medium 13. In at least one implementation, the destination device 12 may include any device configured to receive encoded video data via the communication medium 13 and to decode encoded video data.

In at least one implementation, the source device 11 may wiredly and/or wirelessly communicate with the destination device 12 via the communication medium 13. The source device 11 may include a source module 111, an encoder module 112, and a first interface 113. The destination device 12 may include a display module 121, a decoder module 122, and a second interface 123. In at least one implementation, the source device 11 may be a video encoder, and the destination device 12 may be a video decoder.

In at least one implementation, the source device 11 and/or the destination device 12 may be a mobile phone, a tablet, a desktop, a notebook, or other electronic devices. FIG. 1 merely illustrates one example of the source device 11 and the destination device 12, and the source device 11 and the destination device 12 in other implementations may include more or less components than illustrated or have a different configuration of the various components.

In at least one implementation, the source module 111 of the source device 11 may include a video capture device to capture a new video, a video archive storing previously captured video, and/or a video feed interface to receive video from a video content provider. In at least one implementation, the source module 111 of the source device 11 may generate computer graphics-based data as the source video, or a combination of live video, archived video, and computer-generated video. In at least one implementation, the video capturing device may be a charge-coupled device (CCD) image sensor, a complementary metal-oxide-semiconductor (CMOS) image sensor, or a camera.

In at least one implementation, the encoder module 112 and the decoder module 122 may each be implemented as any of a variety of suitable encoder/decoder circuitry, such as one or more microprocessors, a central processing unit (CPU), a graphic processing unit (GPU), a system on chip (SoC), digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of the present disclosure. In at least one implementation, each of the encoder module 112 and the decoder module 122 may be included in one or more encoders or decoders, any of which may be integrated as part of a combined encoder/decoder (CODEC) in a respective device.

In at least one implementation, the first interface 113 and the second interface 123 may adopt customized protocols or follow existing standards or de facto standards including, but not limited to, Ethernet, IEEE 802.11 or IEEE 802.15 series, Wireless USB or telecommunication standards including, but not limited to, GSM, CDMA2000, TD-SCDMA, WiMAX, 3GPP-LTE or TD-LTE. In at least one implementation, the first interface 113 and the second interface 123 may each include any device configured to transmit and/or store a compliant video bitstream to the communication medium 13 and to receive the compliant video bitstream from the communication medium 13. In at least one implementation, the first interface 113 and the second interface 123 may include a computer system interface that may enable a compliant video bitstream to be stored on a storage device or to be received from the storage device. For example, the first interface 113 and the second interface 123 may include a chipset supporting Peripheral Component Interconnect (PCI) and Peripheral Component Interconnect Express (PCIe) bus protocols, proprietary bus protocols, Universal Serial Bus (USB) protocols, I2C, or any other logical and physical structure that may be used to interconnect peer devices.

In at least one implementation, the display module 121 may include a display using liquid crystal display (LCD) technology, a plasma display technology, an organic light emitting diode (OLED) display technology, or light emitting polymer display (LPD) technology, although other display technologies may be used in other implementations. In at least one implementation, the display module 121 may include a high definition display or an ultra high definition display.

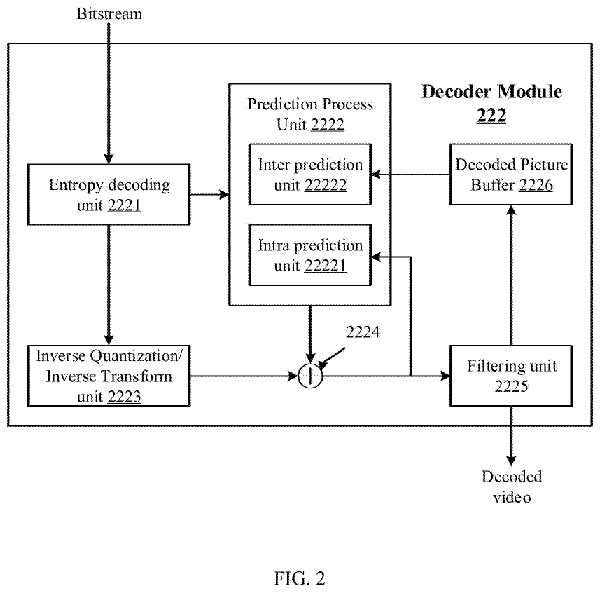

FIG. 2 is a block diagram of a decoder module 222 representing an example implementation of the decoder module 122 of the destination device 12 in the system of FIG. 1, according to an example implementation of the present application. In at least one implementation, the decoder module 222 includes an entropy decoder (e.g., an entropy decoding unit 2221), a prediction processor (e.g., a prediction process unit 2222), an inverse quantization/inverse transform processor (e.g., an inverse quantization/inverse transform unit 2223), a summer (e.g., a first summer 2224), a filter (e.g., a filtering unit 2225), and a decoded picture buffer (e.g., a decoded picture buffer 2226). In at least one implementation, the prediction process unit 2222 of the decoder module 222 further includes an intra prediction processor (e.g., an intra prediction unit 22221) and an inter prediction processor (e.g., an inter prediction unit 22222). In at least one implementation, the decoder module 222 receives a bitstream, and decodes the bitstream to output a decoded video.

In at least one implementation, the entropy decoding unit 2221 may receive the bitstream including a plurality of syntax elements from the second interface 123 in FIG. 1 and perform a parsing operation on the bitstream to extract syntax elements from the bitstream. As part of performing the parsing operation, the entropy decoding unit 2221 may entropy decode the bitstream to generate quantized transform coefficients, quantization parameters, transform data, motion vectors, intra modes, partition information, and other syntax information. In at least one implementation, the entropy decoding unit 2221 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique to generate the quantized transform coefficients. In at least one implementation, the entropy decoding unit 2221 may provide the quantized transform coefficients, the quantization parameters, and the transform data to the inverse quantization/inverse transform unit 2223, and provide the motion vectors, the intra modes, the partition information, and other syntax information to the prediction process unit 2222.

In at least one implementation, the prediction process unit 2222 may receive syntax elements, such as motion vectors, intra modes, partition information, and other syntax information, from the entropy decoding unit 2221. In at least one implementation, the prediction process unit 2222 may receive the syntax elements including the partition information, and then divide image frames according to the partition information. In at least one implementation, each of the image frames may be divided into at least one image block according to the partition information. The at least one image block may include a luminance block for reconstructing a plurality of luminance samples, and at least one chrominance block for reconstructing a plurality of chrominance samples. The luminance block and the at least one chrominance block may be further divided to generate macroblocks, coding tree units (CTUs), coding blocks (CBs), sub-divisions thereof, and/or another equivalent coding unit.

In at least one implementation, during the decoding process, the prediction process unit 2222 receives predicted data including the intra mode or the motion vector for a current image block of a specific one of the image frames. The current image block may be one of the luminance block and the at least one of the chrominance block in the specific image frame.

In at least one implementation, the intra prediction unit 22221 may perform intra-predictive coding of a current block unit relative to one or more neighboring blocks in the same frame as the current block unit based on the syntax elements related to the intra mode to generate a predicted block. In at least one implementation, the intra mode may specify the location of reference samples selected from the neighboring blocks within the current frame.

In at least one implementation, the intra prediction unit 22221 may reconstruct a plurality of chroma components of the current block unit based on the plurality of luma components of the current block unit, when the luma components of the current block are reconstructed by the prediction process unit 2222.

In at least one implementation, the inter prediction unit 22222 may perform inter-predictive coding of the current block unit relative to one or more blocks in one or more reference image blocks based on the syntax elements related to the motion vector to generate the predicted block. In at least one implementation, the motion vector may indicate a displacement of the current block unit within the current image block relative to a reference block unit within the reference image block. The reference block unit is a block that is determined to closely match the current block unit. In at least one implementation, the inter prediction unit 22222 receives the reference image block stored in the decoded picture buffer 2226 and reconstructs the current block unit based on the received reference image blocks.

In at least one implementation, the inverse quantization/inverse transform unit 2223 may apply inverse quantization and inverse transformation to reconstruct the residual block in the pixel domain. In at least one implementation, the inverse quantization/inverse transform unit 2223 may apply inverse quantization to the residual quantized transform coefficient to generate a residual transform coefficient, and then apply inverse transformation to the residual transform coefficient to generate the residual block in the pixel domain. In at least one implementation, the inverse transformation may be inversely applied by the transformation process, such as discrete cosine transform (DCT), discrete sine transform (DST), adaptive multiple transform (AMT), mode-dependent non-separable secondary transform (MDNSST), hypercube-givens transform (HyGT), signal dependent transform, Karhunen-Loéve transform (KLT), wavelet transform, integer transform, sub-band transform or a conceptually similar transform. In at least one implementation, the inverse transformation may convert the residual information from a transform domain, such as a frequency domain, back to the pixel domain. In at least one implementation, the degree of inverse quantization may be modified by adjusting a quantization parameter.

In at least one implementation, the first summer 2224 adds the reconstructed residual block to the predicted block provided from the prediction process unit 2222 to produce a reconstructed block.

In at least one implementation, the filtering unit 2225 may include a deblocking filter, a sample adaptive offset (SAO) filter, a bilateral filter, and/or an adaptive loop filter (ALF) to remove blockiness artifacts from the reconstructed block. Additional filters (in loop or post loop) may also be used in addition to the deblocking filter, the SAO filter, the bilateral filter and the ALF. Such filters are not shown for brevity, but if desired, may filter the output of the first summer 2224. In at least one implementation, the filtering unit 2225 may output the decoded video to the display module 121 or other video receiving unit, after the filtering unit 2225 performs the filtering process for the reconstructed blocks of the specific image frame.

In at least one implementation, the decoded picture buffer 2226 may be a reference picture memory that stores the reference block for use in decoding the bitstream by the prediction process unit 2222, e.g., in inter-coding modes. The decoded picture buffer 2226 may be formed by any of a variety of memory devices, such as dynamic random access memory (DRAM), including synchronous DRAM (SDRAM), magneto-resistive RAM (MRAM), resistive RAM (RRAM), or other types of memory devices. In at least one implementation, the decoded picture buffer 2226 may be on-chip with other components of the decoder module 222, or off-chip relative to those components.

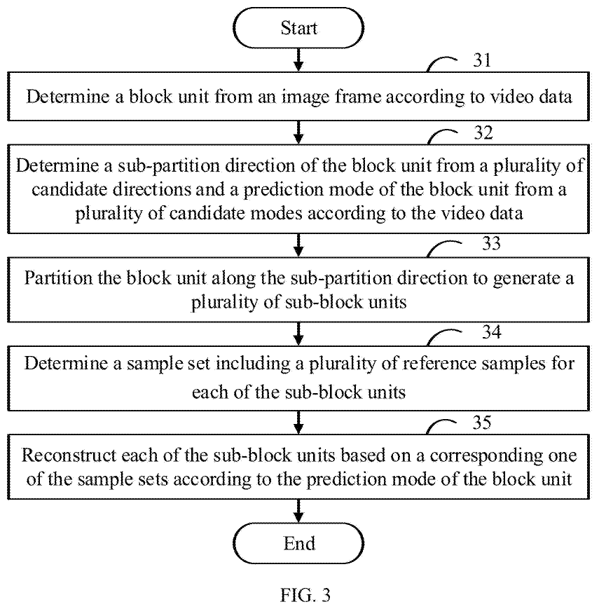

FIG. 3 illustrates a flowchart in accordance with an example implementation of a prediction method for predicting a plurality of sub-block units based on different reference samples according to the same prediction mode, according to an example implementation of the present application. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 3 represents one or more processes, methods, or subroutines, carried out in the example method. Furthermore, the order of blocks is illustrative only and may change. Additional blocks may be added or less blocks may be utilized without departing from the present disclosure.

At block 31, the decoder module 222 determines a block unit from an image frame according to video data.

In at least one implementation, the video data may be a bitstream. In at least one implementation, the destination device 12 may receive the bitstream from an encoder, such as the source device 11, via the second interface 123 of the destination device 12. The second interface 123 may provide the bitstream to the decoder module 222. The decoder module 222 may determine the image frame based on the bitstream and divide the image frame to determine the block unit according to a plurality of partition indications in the bitstream. For example, the decoder module 222 may divide the image frames to generate a plurality of coding tree units, and further divide one of the coding tree units to determine the block unit according to the partition indications based on a video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 32, the prediction process unit 2222 determines a sub-partition direction of the block unit from a plurality of candidate directions and a prediction mode of the block unit from a plurality of candidate modes according to the video data.

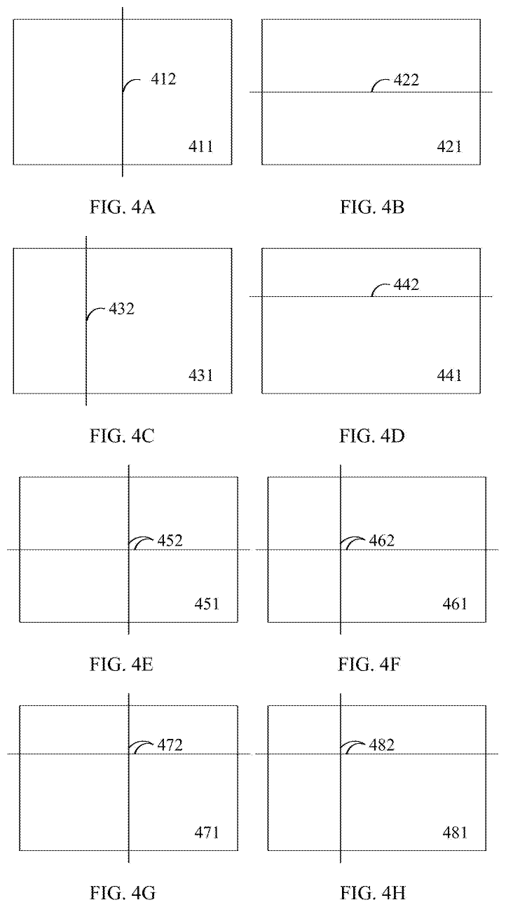

In at least one implementation, the prediction process unit 2222 of the destination device 12 may select the sub-partition direction from the candidate directions. In at least one implementation, the candidate directions may include a horizontal direction and a vertical direction. In at least one implementation, the candidate directions may include a cross direction having the horizontal direction and the vertical direction. FIGS. 4A-4H are schematic illustrations of example implementations of the block unit divided along different candidate directions, according to an example implementation of the present application. In at least one implementation, a block unit 411 may be divided along a vertical direction 412, and a block unit 431 may be divided along a vertical direction 432. In at least one implementation, a block unit 421 may be divided along a horizontal direction 422, and a block unit 441 may be divided along a horizontal direction 442. In at least one implementation, a block unit 451 may be divided along a cross direction 452, a block unit 461 may be divided along a cross direction 462, a block unit 471 may be divided along a cross direction 472, and a block unit 481 may be divided along a cross direction 482. In at least one implementation, each of the cross directions 452, 462, 472, and 482 may include the horizontal direction and the vertical direction.

In at least one implementation, the candidate modes may be selected from a plurality of intra prediction modes including a plurality of angular modes, and a plurality of non-angular modes. In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, Nm may be equal to 4, when the number of the intra prediction modes is equal to 33. In at least one implementation, Nm may be equal to 8, when the number of the intra prediction modes is equal to 65. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 33, the prediction process unit 2222 partitions the block unit along the sub-partition direction to generate a plurality of sub-block units.

In at least one implementation, the number of the sub-block units may be equal to two, when the sub-partition direction is one of the horizontal direction and the vertical direction. In at least one implementation, the number of the sub-block units may be equal to four, when the sub-partition direction is the cross direction.

In at least one implementation, the block unit may be equally divided along the sub-partition direction to generate the sub-block units having equal sizes. In at least one implementation, the block unit may be unequally divided along the sub-partition direction to generate the sub-block units having unequal sizes. In at least one implementation, a block size of the block unit may include a block height and a block width, and a sub-block size for each of the sub-block units may include a sub-block height and a sub-block width. In at least one implementation, the block width may be equally divided into the sub-block widths, when the block unit is equally divided along the vertical direction, such as the vertical direction 412, and the vertical directions of the cross directions 452 and 472. In at least one implementation, the block height may be equally divided into the sub-block heights, when the block unit is equally divided along the horizontal direction, such as the horizontal direction 422, and the horizontal directions of the cross directions 452 and 462. In at least one implementation, the sub-block widths may not be identical to each other, when the block unit is unequally divided along the vertical direction, such as the vertical direction 432, and the vertical directions of the cross directions 462 and 482. In at least one implementation, the sub-block heights may not be identical to each other, when the block unit is unequally divided along the horizontal direction, such as the horizontal direction 442, and the horizontal directions of the cross directions 472 and 482. In at least one implementation, the block width may be equal to or different from the block height, and the sub-block width may be equal to or different from the sub-block height.

At block 34, the intra prediction unit 22221 determines a sample set including a plurality of reference samples for each of the sub-block units.

In at least one implementation, the intra prediction unit 22221 may select a plurality of neighboring samples of a specific one of the sub-block units as the reference samples and add the reference samples of the specific sub-block unit to a corresponding one of the sample sets. In at least one implementation, the neighboring samples may be selected for the specific sub-block unit from a plurality of neighboring blocks of the block unit and one or more other sub-block units neighboring the specific sub-block unit.

In at least one implementation, the neighboring blocks include a plurality of first neighboring blocks located above the block unit and a plurality of second neighboring blocks located to the left side of the block unit. In at least one implementation, each of the neighboring samples may be selected from the neighboring blocks, when the specific sub-block unit includes a first block component located at the top-left corner of the block unit. In at least one implementation, the neighboring samples may be selected from the first neighboring blocks and one of the sub-block units located to the left side of the specific sub-block unit, when the specific sub-block unit includes a second block component located at the upper boundary of the block unit and excludes the first block component. In at least one implementation, the neighboring samples may be selected from the second neighboring blocks and one of the sub-block units located above the specific sub-block unit, when the specific sub-block unit includes a third block component located at the left boundary of the block unit and excludes the first block component. Thus, the neighboring samples of the specific sub-block unit may be selected from the neighboring blocks and the one or more other sub-block units neighboring the specific sub-block unit, when the specific sub-block unit is not located at the top-left corner of the block unit. In at least one implementation, the neighboring samples of the specific sub-block unit may be selected only from the one or more other sub-block units neighboring the specific sub-block unit, when the specific sub-block unit does not include the first block component, the second block component, and the third block component. In other words, the neighboring samples of the specific sub-block unit may be selected only from the one or more other sub-block units neighboring the specific sub-block unit, when the specific sub-block unit is located at a bottom-right corner of the block unit.

At block 35, the decoder module 222 reconstructs each of the sub-block units based on a corresponding one of the sample sets according to the prediction mode of the block unit.

In at least one implementation, each of the sub-block units may be reconstructed based on different sample sets according to the same prediction mode. For example, a first one of the sub-block units may be reconstructed based on a first one of the sample sets corresponding to the first sub-block unit according to the prediction mode of the block unit, and a second one of the sub-block units may be reconstructed based on a second one of the sample sets corresponding to the second sub-block unit according to the prediction mode of the block unit.

In at least one implementation, the decoder module 222 may generate a plurality of predicted components for each of the sub-block units based on the corresponding one of the sample sets according to the prediction mode of the block unit. In at least one implementation, the first summer 2224 of the decoder module 222 in the destination device 12 may add the predicted components to a plurality of residual components determined from the bitstream to reconstruct each of the sub-block units. In addition, the decoder module 222 may reconstruct all of the other block units in the image frame for reconstructing the image frame and the video.

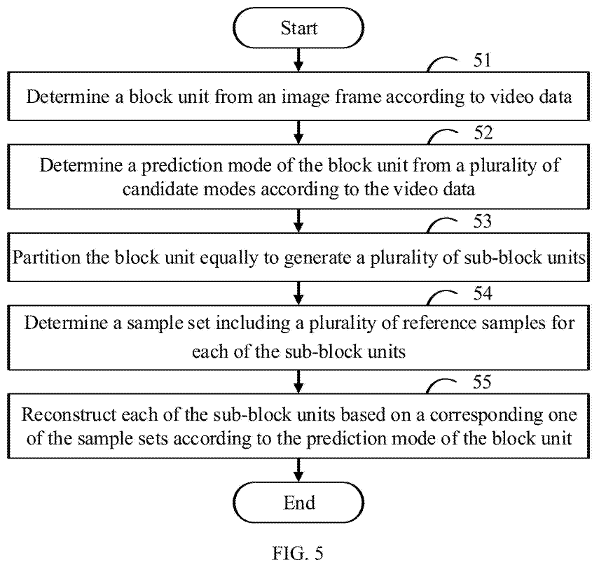

FIG. 5 illustrates a flowchart in accordance with an example implementation of a prediction method for predicting a plurality of sub-block units based on different reference samples according to the same prediction mode, according to an example implementation of the present application. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 5 represents one or more processes, methods, or subroutines, carried out in the example method. Furthermore, the order of blocks is illustrative only and may change. Additional blocks may be added or less blocks may be utilized without departing from the present disclosure.

At block 51, the decoder module 222 determines a block unit from an image frame according to video data.

In at least one implementation, the video data may be a bitstream. In at least one implementation, the destination device 12 may receive the bitstream from an encoder, such as the source device 11, via the second interface 123 of the destination device 12. The second interface 123 may provide the bitstream to the decoder module 222. The decoder module 222 may determine the image frame based on the bitstream and divide the image frame to determine the block unit according to a plurality of partition indications in the bitstream. For example, the decoder module 222 may divide the image frames to generate a plurality of coding tree units, and further divide one of the coding tree units to determine the block unit according to the partition indications based on a video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 52, the prediction process unit 2222 determines a prediction mode of the block unit from a plurality of candidate modes according to the video data.

In at least one implementation, the candidate modes may be selected from a plurality of intra prediction modes including a plurality of angular modes, and a plurality of non-angular modes. In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, Nm may be equal to 4, when the number of the intra prediction modes is equal to 33. In at least one implementation, Nm may be equal to 8, when the number of the intra prediction modes is equal to 65. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 53, the prediction process unit 2222 partitions the block unit equally to generate a plurality of sub-block units.

In at least one implementation, the prediction process unit 2222 of the destination device 12 may select a sub-partition direction from a plurality of candidate directions. In at least one implementation, the candidate directions may include a horizontal direction and a vertical direction. In at least one implementation, the candidate directions may include a cross direction having the horizontal direction and the vertical direction. FIGS. 4A, 4B and 4E are schematic illustrations of example implementations of the block unit divided equally along different candidate directions. In at least one implementation, the block unit 411 may be divided equally along the vertical direction 412, and the block unit 421 may be divided equally along the horizontal direction 422. In at least one implementation, the block unit 451 may be divided equally along the cross direction 452. In at least one implementation, the cross directions 452 may include the horizontal direction and the vertical direction. In at least one implementation, the number of the sub-block units may be equal to two, when the sub-partition direction is one of the horizontal direction and the vertical direction. In at least one implementation, the number of the sub-block units may be equal to four, when the sub-partition direction is the cross direction.

In at least one implementation, a plurality of sub-block sizes for the sub-block units is identical to each other, when the block unit is equally divided along the sub-partition direction. In at least one implementation, a block size of the block unit may include a block height and a block width, and each of the sub-block sizes includes a sub-block height and a sub-block width. In at least one implementation, the block width may be equally divided into the sub-block widths, when the block unit is equally divided along the vertical direction, such as the vertical direction 412, and the vertical direction of the cross direction 452. In at least one implementation, the block height may be equally divided into the sub-block heights, when the block unit is equally divided along the horizontal direction, such as the horizontal direction 422, and the horizontal direction of the cross direction 452. In at least one implementation, the block width may be equal to or different from the block height, and the sub-block width may be equal to or different from the sub-block height.

At block 54, the intra prediction unit 22221 determines a sample set including a plurality of reference samples for each of the sub-block units.

In at least one implementation, the intra prediction unit 22221 may select a plurality of neighboring samples neighboring a specific one of the sub-block units as the reference samples and add the reference samples of the specific sub-block unit to a corresponding one of the sample sets. In at least one implementation, the neighboring samples may be selected for the specific sub-block unit from a plurality of neighboring blocks of the block unit and one or more other sub-block units neighboring the specific sub-block unit.

In at least one implementation, the neighboring blocks include a plurality of first neighboring blocks located above the block unit and a plurality of second neighboring blocks located to the left side of the block unit. In at least one implementation, each of the neighboring samples may be included in the neighboring blocks, when the specific sub-block unit includes a first block component located at the top-left corner of the block unit. In at least one implementation, the neighboring samples may be selected from the first neighboring blocks and one of the sub-block units located to the left side of the specific sub-block unit, when the specific sub-block unit includes a second block component located at the upper boundary of the block unit and excludes the first block component. In at least one implementation, the neighboring samples may be selected from the second neighboring blocks and one of the sub-block units located above the specific sub-block unit, when the specific sub-block unit includes a third block component located at the left boundary of the block unit and excludes the first block component. Thus, the neighboring samples of the specific sub-block unit may be selected from the neighboring blocks and the one or more other sub-block units neighboring the specific sub-block unit, when the specific sub-block unit is not located at the top-left corner of the block unit. In at least one implementation, the neighboring samples of the specific sub-block unit may be selected only from the one or more other sub-block units neighboring the specific sub-block unit, when the specific sub-block unit does not include the first block component, the second block component, and the third block component. In other words, the neighboring samples of the specific sub-block unit may be selected only from the one or more other sub-block units neighboring the specific sub-block unit, when the specific sub-block unit is located at a bottom-right corner of the block unit.

At block 55, the decoder module 222 reconstructs each of the sub-block units based on a corresponding one of the sample sets according to the prediction mode of the block unit.

In at least one implementation, each of the sub-block units may be reconstructed based on different sample sets according to the same prediction mode. For example, a first one of the sub-block units may be reconstructed based on a first one of the sample sets corresponding to the first sub-block unit according to the prediction mode of the block unit, and a second one of the sub-block units may be reconstructed based on a second one of the sample sets corresponding to the second sub-block unit according to the prediction mode of the block unit.

In at least one implementation, the decoder module 222 may generate a plurality of predicted components for each of the sub-block units based on the corresponding one of the sample sets according to the prediction mode of the block unit. In at least one implementation, the first summer 2224 of the decoder module 222 in the destination device 12 may add the predicted components to a plurality of residual components determined from the bitstream to reconstruct each of the sub-block units. In addition, the decoder module 222 may reconstruct all of the other block units in the image frame for reconstructing the image frame and the video.

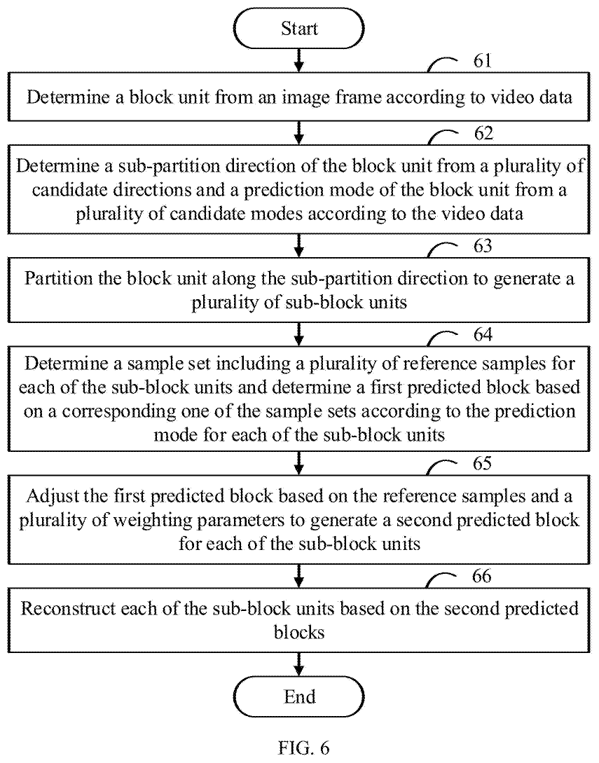

FIG. 6 illustrates a flowchart in accordance with an example implementation of a prediction method for predicting a plurality of sub-block units based on different reference samples according to the same prediction mode, according to an example implementation of the present application. The example method is provided by way of example only, as there are a variety of ways to carry 7 out the method. The method described below may be carried out using the configurations illustrated in FIG. 1 and FIG. 2, for example, and various elements of these figures are referenced in explaining the example method. Each block shown in FIG. 6 represents one or more processes, methods, or subroutines, carried out in the example method. Furthermore, the order of blocks is illustrative only and may change. Additional blocks may be added or less blocks may be utilized without departing from the present disclosure.

At block 61, the decoder module 222 determines a block unit from an image frame according to video data.

In at least one implementation, the video data may be a bitstream. In at least one implementation, the destination device 12 may receive the bitstream from an encoder, such as the source device 11, via the second interface 123 of the destination device 12. The second interface 123 may provide the bitstream to the decoder module 222. The decoder module 222 may determine the image frame based on the bitstream and divide the image frame to determine the block unit according to a plurality of partition indications in the bitstream. For example, the decoder module 222 may divide the image frames to generate a plurality of coding tree units, and further divide one of the coding tree units to determine the block unit according to the partition indications based on a video coding standard.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 62, the prediction process unit 2222 determines a sub-partition direction of the block unit from a plurality of candidate directions and a prediction mode of the block unit from a plurality of candidate modes according to the video data.

In at least one implementation, the prediction process unit 2222 of the destination device 12 may select the sub-partition direction from the candidate directions. In at least one implementation, the candidate directions may include a horizontal direction and a vertical direction. In at least one implementation, the candidate directions may include a cross direction having the horizontal direction and the vertical direction. FIGS. 4A-4H are schematic illustrations of example implementations of the block unit divided along different candidate directions. In at least one implementation, the block unit 411 may be divided along the vertical direction 412, and the block unit 431 may be divided along the vertical direction 432. In at least one implementation, the block unit 421 may be divided along the horizontal direction 422, and the block unit 441 may be divided along the horizontal direction 442. In at least one implementation, the block unit 451 may be divided along the cross direction 452, the block unit 461 may be divided along the cross direction 462, the block unit 471 may be divided along the cross direction 472, and the block unit 481 may be divided along the cross direction 482. In at least one implementation, each of the cross directions 452, 462, 472, and 482 may include the horizontal direction and the vertical direction.

In at least one implementation, the candidate modes may be selected from a plurality of intra prediction modes including a plurality of angular modes, and a plurality of non-angular modes. In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, Nm may be equal to 4, when the number of the intra prediction modes is equal to 33. In at least one implementation, Nm may be equal to 8, when the number of the intra prediction modes is equal to 65. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 63, the prediction process unit 2222 partitions the block unit along the sub-partition direction to generate a plurality of sub-block units.

In at least one implementation, the number of the sub-block units may be equal to two, when the sub-partition direction is one of the horizontal direction and the vertical direction.

In at least one implementation, the number of the sub-block units may be equal to four, when the sub-partition direction is the cross direction.

In at least one implementation, the block unit may be equally divided along the sub-partition direction to generate the sub-block units having equal sizes. In at least one implementation, the block unit may be unequally divided along the sub-partition direction to generate the sub-block units having unequal sizes. In at least one implementation, a block size of the block unit may include a block height and a block width, and a sub-block size for each of the sub-block units may include a sub-block height and a sub-block width. In at least one implementation, the block width may be equally divided into the sub-block widths, when the block unit is equally divided along the vertical direction, such as the vertical direction 412, and the vertical directions of the cross directions 452 and 472. In at least one implementation, the block height may be equally divided into the sub-block heights, when the block unit is equally divided along the horizontal direction, such as the horizontal direction 422, and the horizontal directions of the cross directions 452 and 462. In at least one implementation, the sub-block widths may not be identical to each other, when the block unit is unequally divided along the vertical direction, such as the vertical direction 432, and the vertical directions of the cross directions 462 and 482. In at least one implementation, the sub-block heights may not be identical to each other, when the block unit is unequally divided along the horizontal direction, such as the horizontal direction 442, and the horizontal directions of the cross directions 472 and 482. In at least one implementation, the block width may be equal to or different from the block height, and the sub-block width may be equal to or different from the sub-block height.

At block 64, the intra prediction unit 22221 determines a sample set including a plurality of reference samples for each of the sub-block units and determines a first predicted block based on a corresponding one of the sample sets according to the prediction mode for each of the sub-block units.

In at least one implementation, the intra prediction unit 22221 may select a plurality of neighboring samples of a specific one of the sub-block units as the reference samples and add the reference samples of the specific sub-block unit to a corresponding one of the sample sets. In at least one implementation, the neighboring samples may be selected for the specific sub-block unit from a plurality of neighboring blocks of the block unit and one or more other sub-block units neighboring the specific sub-block unit.

In at least one implementation, the neighboring blocks include a plurality of first neighboring blocks located above the block unit and a plurality of second neighboring blocks located to the left side of the block unit. In at least one implementation, each of the neighboring samples may be selected from the neighboring blocks, when the specific sub-block unit includes a first block component located at the top-left corner of the block unit. In at least one implementation, the neighboring samples may be selected from the first neighboring blocks and one of the sub-block units located to the left side of the specific sub-block unit, when the specific sub-block units includes a second block component located at the upper boundary of the block unit and excludes the first block component. In at least one implementation, the neighboring samples may be selected from the second neighboring blocks and one of the sub-block units located above the specific sub-block unit, when the specific sub-block units includes a third block component located at the left boundary of the block unit and excludes the first block component. Thus, the neighboring samples of the specific sub-block unit may be selected from the neighboring blocks and the one or more other sub-block units neighboring the specific sub-block unit, when the specific sub-block unit is not located at the top-left corner of the block unit. In at least one implementation, the neighboring samples of the specific sub-block unit may be selected only from the one or more other sub-block units neighboring the specific sub-block unit, when the specific sub-block unit does not include the first block component, the second block component, and the third block component. In other words, the neighboring samples of the specific sub-block unit may be selected only from the one or more other sub-block units neighboring the specific sub-block unit, when the specific sub-block unit is located at a bottom-right corner of the block unit.

In at least one implementation, each of the sub-block units may be reconstructed based on different sample sets according to the same prediction mode. For example, a first one of the sub-block units may be reconstructed based on a first one of the sample sets corresponding to the first sub-block unit according to the prediction mode of the block unit, and a second one of the sub-block units may be reconstructed based on a second one of the sample sets corresponding to the second sub-block unit according to the prediction mode of the block unit.

At block 65, the intra prediction unit 22221 adjusts the first predicted block based on the reference samples and a plurality of weighting parameters to generate a second predicted block for each of the sub-block units.

In at least one implementation, each of the sub-block units may include a plurality of block components, each of first predicted blocks may include a plurality of first predicted components that each corresponds to one of the block components, and each of second predicted blocks may include a plurality of second predicted components that each corresponds to one of the block components and one of the first predicted components. In at least one implementation, the first predicted components in a specific one of the first predicted blocks may be adjusted based on a plurality of component locations of the first predicted components in the specific predicted block.

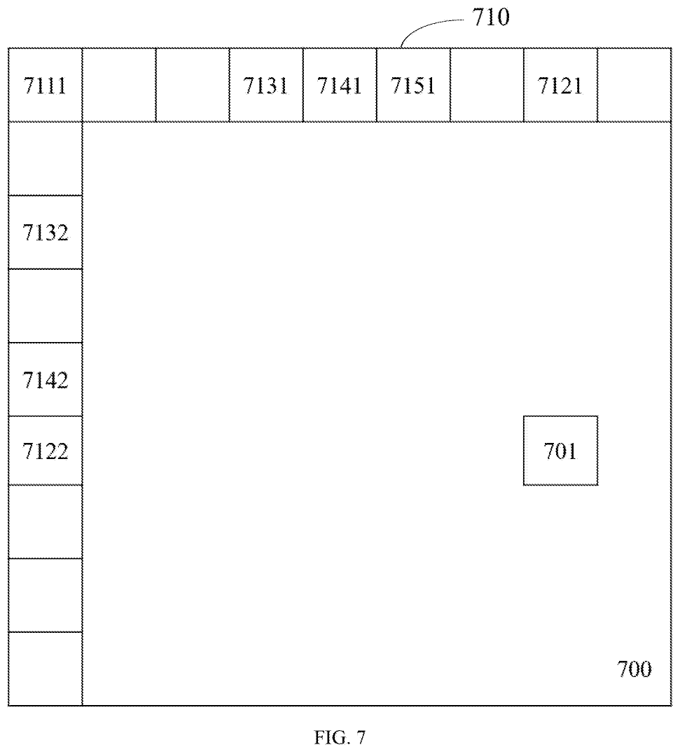

FIG. 7 is a schematic illustration of an example implementation of a sub-block unit and a plurality of adjusting samples neighboring the sub-block unit, according to an example implementation of the present application. In at least one implementation, adjusting samples 710 may be determined from the sample set of a sub-block unit 700 for adjusting the first predicted block of the sub-block unit 700. In at least one implementation, the adjusting samples of a block component 701 may be determined based on at least one of the component locations of the block component 701 and the sub-block size of the sub-block unit 700, and may be selected based on a predefined sample location corresponding to the sub-block unit 700. In at least one implementation, an adjusting sample 7111 may be selected for each of the block components in the sub-block unit 700 based on the predefined sample location (−1, −1). In at least one implementation, the adjusting samples S_{(x, -1)}, S_{(-1, y)}, S_{([x/2]-1, -1)}, and S_{(-1, [y/2]-1)} may be determined based on the component location (x, y) for each of the block components. For example, the adjusting samples S_{(x, -1)}, S_{(-1, y)}, S_{([x/2]-1, -1)}, and S_{(-1, [y/2]-1)} may be adjusting samples 7121, 7122, 7131 and 7132, respectively, located at a plurality of sample locations (6, −1), (−1, 4), (2, −1), and (−1, 1), when the block component 701 is located at the component location (6, 4) of the sub-block unit 700. In at least one implementation, the adjusting samples S_{([W/2]-1, -1)}, and S_{(-1, [H/2]-1)} may be determined based on the sub-block width W and the sub-block height H for each of the block components. For example, the adjusting samples S_{([W/2]-1, -1)}, and S_{(-1, [H/2]-1)} may be adjusting samples 7141 and 7142 located, respectively, at the sample locations (3, −1), and (−1, 3), when the sub-block size of the sub-block unit 700 is 8×8. In at least one implementation, the adjusting samples S_{(x+[(W-x)/2]-1, -1)}, and S_{(-1, y+[(H-y)/2]-1)} may be determined based on the sub-block width W, the sub-block height H and the component location (x, y) for each of the block components. For example, the adjusting samples S_{(x+[(W-x)/2]-1, -1)}, and S_{(-1, y+[(H-y)/2]-1)} may be adjusting samples 7121 and 7152 located, respectively, at the sample locations (6, −1), and (−1, 5), when the block component 701 is located at the component location (6, 4) and the sub-block size of the sub-block unit 700 is 8×8.

In at least one implementation, the adjusting samples of the block component may only include S_{(-1, -1)}, S_{(x, -1)}, and S_{(-1, y)}, when the block component 701 is located at the component location (x, y). In at least one implementation, the adjusting samples of the block component may only include S_{(-1, -1)}, S_{(x, -1)}, S_{(-1, y)}, S_{([x/2]-1, -1)}, and S_{(-1, [y/2]-1)}, when the block component 701 is located at the component location (x, y). In at least one implementation, the adjusting samples of the block component may only include S_{(-1, -1)}, S_{(x, -1)}, S_{(-1, y)}, S_{([W/2]-1, -1)}, and S_{(-1, [H/2]-1)}, when the block component 701 is located at the component location (x, y) and the sub-block size of the sub-block unit 700 is W×H. In at least one implementation, the adjusting samples of the block component may only include S_{(-1, -1)}, S_{(x, -1)}, S_{(-1, y)}, S_{([x/2]-1, -1)}, S_{(-1, [y/2]-1)}, S_{([W/2]-1, -1)}, S_{(-1, [H/2]-1)}, S_{(x+[(W-x)/2]-1, -1)}, and S_{(-1, y+[(H-y)/2]-1)}, when the block component 701 is located at the component location (x, y) and the sub-block size of the sub-block unit 700 is W×H. In at least one implementation, each of the sample locations corresponding to the component location may be different from each other. In at least one implementation, some of the sample locations corresponding to the component location may overlap each other. For example, the adjusting samples S_{(x, -1)}, and S_{(x+[(W-x)/2]-1, -1)} may be located at the sample location (6, −1), when the block component 701 in the sub-block unit 700, having the sub-block size 8×8, is located at the component location (6, 4). In at least one implementation, one of the overlapped adjusting samples may remain in the adjusted samples, and the other overlapped adjusted samples may be omitted. In at least one implementation, each of the overlapped adjusting samples may remain in the adjusting samples.

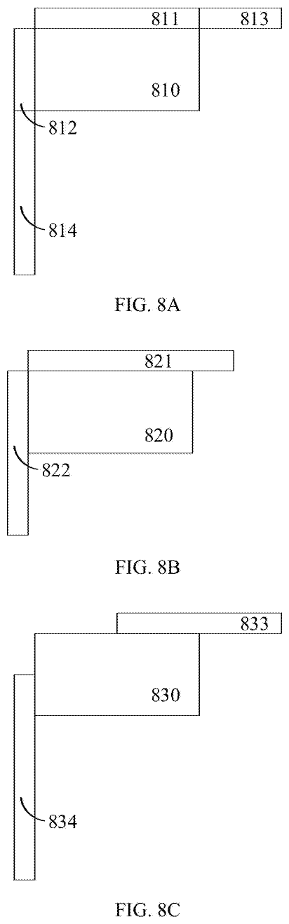

In at least one implementation, the sample set of the sub-block unit may be further divided to generate a plurality of sample regions. FIGS. 8A, 8B and 8C are schematic illustrations of example implementations of a sub-block unit and different sample regions, according to an example implementation of the present application. In at least one implementation, the sample set of a sub-block unit 810 may be divided to generate a top sample region 811, a left sample region 812, a top-right sample region 813, and a bottom-left sample region 814. In at least one implementation, the sample set of a sub-block unit 820 may be divided to generate a top sample region 821, and a left sample region 822. In at least one implementation, the sample set of a sub-block unit 830 may be divided to generate a top-right sample region 833, and a bottom-left sample region 834. In at least one implementation, a first region width of the top sample region 811 and a first region height of the bottom-left sample region 814 may be identical to the block width W, and a second region width of the top-right sample region 813 and a second region height of the left sample region 812 may be identical to the block height H. In at least one implementation, a third region width of the top sample region 821 may be longer than the first region width and shorter than a first addition of the first region width and the second region width, and a third region height of the left sample region 822 may be longer than the second region height and shorter than a second addition of the first region height and the second region height. In at least one implementation, a fourth region width of the top-right sample region 833 may be longer than the second region width and shorter than the first addition of the first region width and the second region width, and a fourth region height of the bottom-left sample region 834 may be longer than the first region height and shorter than the second addition of the first region height and the second region height.

In at least one implementation, the reference samples in the sample regions may be selected to be added to the adjusting samples. For example, the intra prediction unit 22221 may select Na reference samples in the top sample region, Nb reference samples in the left sample region, Nc reference samples in the top-right sample region, and Nd reference samples in the bottom-left sample region, and add the selected reference samples to the adjusting samples. In at least one implementation, each of the numbers Na, Nb, Nc, and Nd may be a predefined integer greater than or equal to zero. In at least one implementation, each of the numbers Na, Nb, Nc, and Nd may be different from, or equal to, each other. In at least one implementation, some of the numbers Na, Nb, Nc, and Nd may be different from each other, and the others may be equal to each other.

In at least one implementation, a specific one of the first predicted components and the adjusting samples corresponding to the specific one of the first predicted components may be combined with the weighting parameters to generate a corresponding one of the second predicted components. In at least one implementation, the number of the weighting parameters may be equal to Ns+1, when the number of the adjusting samples is equal to Ns. In at least one implementation, the number of the weighting parameters for a specific one of the sub-block units may be different from, or equal to, the number of the weighting parameters for the others of the sub-block units. In at least one implementation, the number of the weighting parameters for a left one of the sub-block units may be greater than or equal to the number of the weighting parameters for a right one of the sub-block units, when the sub-partition direction is the vertical direction. In at least one implementation, the number of the weighting parameters for an upper one of the sub-block units may be greater than or equal to the number of the weighting parameters for a lower one of the sub-block units, when the sub-partition direction is the horizontal direction. In at least one implementation, the number of the weighting parameters for each of the four sub-block units may be equal to each other, when the sub-partition direction is the cross direction. In at least one implementation, the number of the weighting parameters for a top-left one of the sub-block units may be greater than the number of the weighting parameters for a bottom-left one of the sub-block units which is greater than the number of the weighting parameters for a top-right one of the sub-block units, when the sub-partition direction is the cross direction. In at least one implementation, the number of the weighting parameters for the top-left sub-block unit may be greater than the number of the weighting parameters for the top-right sub-block unit which is greater than the number of the weighting parameters for the bottom-left sub-block unit, when the sub-partition direction is the cross direction. In at least one implementation, the number of the weighting parameters for the top-left sub-block unit may be greater than the number of the weighting parameters for the top-right sub-block unit which is equal to the number of the weighting parameters for the bottom-left sub-block unit, when the sub-partition direction is the cross direction.

At block 66, the decoder module 222 reconstructs each of the sub-block units based on the second predicted blocks.

In at least one implementation, the first summer 2224 of the decoder module 222 in the destination device 12 may add the second predicted components in each of the second predicted blocks to a plurality of residual components determined from the bitstream to reconstruct the sub-block units. In addition, the decoder module 222 may reconstruct all of the other block units in the image frame for reconstructing the image frame and the video.

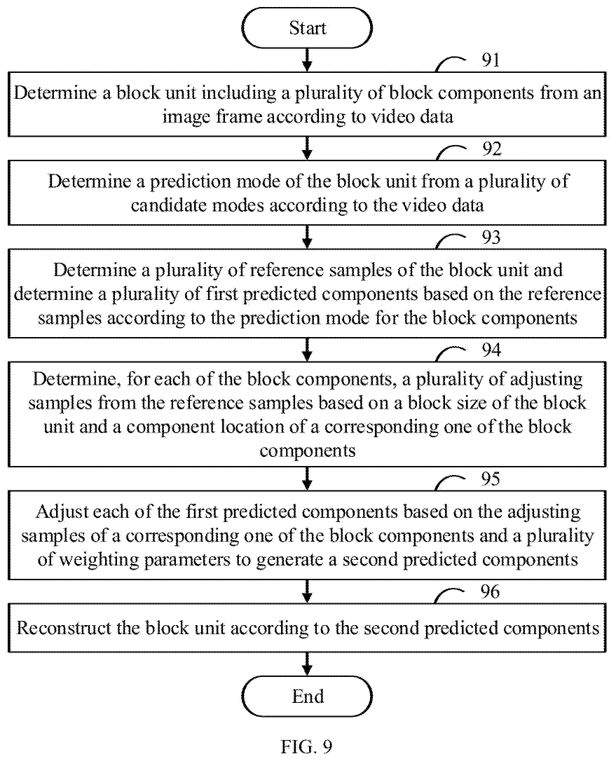

FIG. 9 illustrates a flowchart in accordance with an example implementation of an adjustment method for adjusting a predicted result based on a block size, according to an example implementation of the present application. The example method is provided by way of example only, as there are a variety of ways to carry out the method. The method described below may be carried out using the configurations illustrated in FIG. 1 and FIG. 2, for example, and various elements of these figures are referenced in explaining the example method. Each block shown in FIG. 9 represents one or more processes, methods, or subroutines, carried out in the example method. Furthermore, the order of blocks is illustrative only and may change. Additional blocks may be added or less blocks may be utilized without departing from the present disclosure.

At block 91, the decoder module 222 determines a block unit including a plurality of block components from an image frame according to video data.

In at least one implementation, the video data may be a bitstream. In at least one implementation, the destination device 12 may receive the bitstream from an encoder, such as the source device 11, via the second interface 123 of the destination device 12. The second interface 123 may provide the bitstream to the decoder module 222. The decoder module 222 may determine the image frame based on the bitstream and divide the image frame to determine the block unit according to a plurality of partition indications in the bitstream. For example, the decoder module 222 may divide the image frames to generate a plurality of coding tree units, and further divide one of the coding tree units to determine the block unit according to the partition indications based on a video coding standard. In at least one implementation, the block unit may include the block components.

In at least one implementation, the entropy decoding unit 2221 may decode the bitstream to determine a plurality of prediction indications for the block unit, and then the decoder module 222 may further reconstruct the block unit based on the prediction indications. In at least one implementation, the prediction indications may include a plurality of flags and a plurality of indices.

At block 92, the prediction process unit 2222 determines a prediction mode of the block unit from a plurality of candidate modes according to the video data.

In at least one implementation, the candidate modes may be selected from a plurality of intra prediction modes including a plurality of angular modes, and a plurality of non-angular modes. In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, Nm may be equal to 4, when the number of the intra prediction modes is equal to 33. In at least one implementation, Nm may be equal to 8, when the number of the intra prediction modes is equal to 65. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 93, the intra prediction unit 22221 determines a plurality of reference samples of the block unit and determines a plurality of first predicted components based on the reference samples according to the prediction mode for the block components.

In at least one implementation, the intra prediction unit 22221 may select a plurality of neighboring samples in a plurality of neighboring blocks of the block unit as the reference samples. In at least one implementation, the intra prediction unit 22221 may determine the first predicted components based on the reference samples according to the selected intra prediction mode.

At block 94, the intra prediction unit 22221 determines, for each of the block components, a plurality of adjusting samples from the reference samples based on a block size of the block unit and a component location of a corresponding one of the block components.

In at least one implementation, the intra prediction unit 22221 may determine a specific one of the component locations for a specific one of the block components, when the intra prediction unit 22221 determines the adjusting samples for the specific block components. In at least one implementation, the intra prediction unit 22221 may determine the adjusting samples for the specific block components based on the block size and the specific component location (x, y). In at least one implementation, the block size may include a block width W and a block height H. In at least one implementation, the block width W may be equal to or different from the block height H. FIG. 7 is a schematic illustration of an example implementation of a block unit and a plurality of adjusting samples neighboring the block unit, according to an example implementation of the present application. In at least one implementation, an adjusting sample 710 may be determined from the reference samples of a block unit 700 for adjusting the first predicted block of the block unit 700. In at least one implementation, the adjusting samples of a block component 701 may be determined based on at least one of the component location of the block component 701 and the block size of the block unit 700, and may be selected based on a predefined sample location corresponding to the block unit 700. In at least one implementation, an adjusting sample 7111 may be selected for each of the block components in the block unit 700 based on the predefined sample location (−1, −1). In at least one implementation, the adjusting samples S_{(x, -1)}, S_{(-1, y)}, S_{([x/2]-1, -1)}, and S_{(-1, [y/2]-1)} may be determined based on the component location (x, y) for each of the block components. For example, the adjusting samples S_{(x, -1)}, S_{(-1, y)}, S_{([x/2]-1, -1)}, and S_{(-1, [y/2]-1)} may be adjusting samples 7121, 7122, 7131 and 7132, respectively, located at a plurality of sample locations (6, −1), (−1, 4), (2, −1), and (−1, 1), when the block component 701 is located at the component location (6, 4). In at least one implementation, the adjusting samples S_{([W/2]-1, -1)}, and S_{(-1, [H/2]-1)} may be determined based on the block width W and the block height H for each of the block components. For example, the adjusting samples S_{([W/2]-1, -1)}, and S_{(-1, [H/2]-1)} may be adjusting samples 7141 and 7142 located, respectively, at the sample locations (3, −1), and (−1, 3), when the block size of the block unit 700 is 8×8. In at least one implementation, the adjusting samples S_{(x+[(W-x)/2]-1, -1)}, and S_{(-1, y+[(H-y)/2]-1)} may be determined based on the block width W, the block height H and the component location (x, y) for each of the block components. For example, the adjusting samples S_{x+[(W-x)/2]-1, -1)}, and S_{(-1, y+[(H-y)/2]-1)} may be adjusting samples 7121 and 7152 located, respectively, at the sample locations (6, −1), and (−1, 5), when the block component 701 is located at the component location (6, 4) and the block size of the block unit 700 is 8×8.

In at least one implementation, the adjusting samples of the block component may only include S_{(-1, -1)}, S_{(x, -1)}, and S_{(-1, y)}, when the block component 701 is located at the component location (x, y). In at least one implementation, the adjusting samples of the block component may only include S_{(-1, 1)}, S_{(x, -1)}, S_{(-1, y)}, S_{([x/2]-1, -1)}, and S_{(-1, [y/2]-1)}, when the block component 701 is located at the component location (x, y). In at least one implementation, the adjusting samples of the block component may only include S_{(-1, -1)}, S_{(x, -1)}, S_{(-1, y)}, S_{([W/2]-1, -1)}, and S_{(-1, [H/2]-1)}, when the block component 701 is located at the component location (x, y) and the block size of the block unit 700 is W×H. In at least one implementation, the adjusting samples of the block component may only include S_{(-1, -1)}, S_{(x, -1)}, S_{(-1, y)}, S_{([x/2]-1, -1)}, S_{(-1, [y/2]-1)}, S_{([W/2]-1, -1)}, S_{(-1, [H/2]-1)}, S_{(x+[(W-x)/2]-1, -1)}, and S_{(-1, y+[(H-y)/2]-1)}, when the block component 701 is located at the component location (x, y) and the block size of the block unit 700 is W×H. In at least one implementation, some of the sample locations (−1, −1), (x, −1), ([x/2]−1, −1), ([W/2]−1, −1), and (x+[(W−x)/2]−1, −1) may overlap each other. In addition, some of the sample locations (−1, −1), (−1, y), (−1, [y/2]−1), (−1, [H/2]−1), and (−1, y+[(H−y)/2]−1) may overlap each other. For example, the adjusting samples S_{(x, -1)}, and S_{(x+[(W-x)/2]-1, -1)} may be located at the sample location (6, −1), when the block component 701 is located at the component location (6, 4). In at least one implementation, one of the overlapped adjusting samples may remain in the adjusted samples, and the other overlapped adjusted samples may be omitted. In at least one implementation, each of the overlapped adjusting samples may remain in the adjusting samples.

In at least one implementation, the reference samples of the block unit may be further divided to generate a plurality of sample regions. FIGS. 8A, 8B and 8C are schematic illustrations of example implementations of a block unit and different sample regions, according to an example implementation of the present application. In at least one implementation, the sample set of a block unit 810 may be divided to generate a top sample region 811, a left sample region 812, a top-right sample region 813, and a bottom-left sample region 814. In at least one implementation, the sample set of a block unit 820 may be divided to generate a top sample region 821, and a left sample region 822. In at least one implementation, the sample set of a block unit 830 may be divided to generate a top-right sample region 833, and a bottom-left sample region 834. In at least one implementation, a first region width of the top sample region 811 and a first region height of the bottom-left sample region 814 may be identical to the block width W, and a second region width of the top-right sample region 813 and a second region height of the left sample region 812 may be identical to the block height H. In at least one implementation, a third region width of the top sample region 821 may be longer than the first region width and shorter than a first addition of the first region width and the second region width, and a third region height of the left sample region 822 may be longer than the second region height and shorter than a second addition of the first region height and the second region height. In at least one implementation, a fourth region width of the top-right sample region 833 may be longer than the second region width and shorter than the first addition of the first region width and the second region width, and a fourth region height of the bottom-left sample region 834 may be longer than the first region height and shorter than the second addition of the first region height and the second region height.

In at least one implementation, the reference samples in the sample regions may be selected to be added to the adjusting samples. For example, the intra prediction unit 22221 may select Na reference samples in the top sample region, Nb reference samples in the left sample region, Nc reference samples in the top-right sample region, and Nd reference samples in the bottom-left sample region, and add the selected reference samples to the adjusting samples. In at least one implementation, each of the numbers Na, Nb, Nc, and Nd may be a predefined integer greater than or equal to zero. In at least one implementation, each of the numbers Na, Nb, Nc, and Nd may be different from, or equal to, each other. In at least one implementation, some of the numbers Na, Nb, Nc, and Nd may be different from each other, and the others may be equal to each other.

At block 95, the intra prediction unit 22221 adjusts each of the first predicted components based on the adjusting samples of a conesponding one of the block components and a plurality of weighting parameters to generate a second predicted block.

In at least one implementation, a specific one of the first predicted components and the adjusting samples conesponding to the specific one of the first predicted components may be combined with the weighting parameters to generate a corresponding one of the second predicted components. In at least one implementation, the number of the weighting parameters may be equal to Ns+1, when the number of the adjusting samples is equal to Ns.

At block 96, the decoder module 222 reconstructs the block unit based on the second predicted components.

In at least one implementation, the first summer 2224 of the decoder module 222 in the destination device 12 may add the second predicted components to a plurality of residual components determined from the bitstream to reconstruct the block units. In addition, the decoder module 222 may reconstruct all of the other block units in the image frame for reconstructing the image frame and the video.

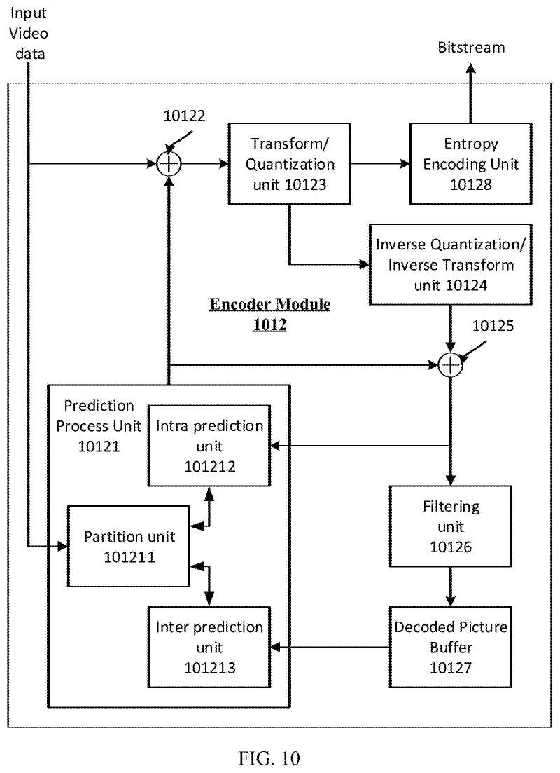

FIG. 10 is a block diagram of an encoder module 1012 representing an example implementation of the encoder module 1012 of the source device 11 in the system of FIG. 1, according to an example implementation of the present application. In at least one implementation, the encoder module 1012 includes a prediction processor (e.g., a prediction process unit 10121), at least one summer (e.g., a first summer 10122 and a second summer 10125), a quantization/inverse transform processor (e.g., a transform/quantization unit 10123), an inverse quantization/inverse transform processor (e.g., an inverse quantization/inverse transform unit 10124), a filter (e.g., a filtering unit 10126), a decoded picture buffer (e.g., a decoded picture buffer 10127), and an entropy encoder (e.g., an entropy encoding unit 10128). In at least one implementation, the prediction process unit 10121 of the encoder module 1012 further includes a partition processor (e.g., a partition unit 101211), an intra prediction processor (e.g., an intra prediction unit 101212), and an inter prediction processor (e.g., an inter prediction unit 101213). In at least one implementation, the encoder module 1012 receives the source video, and encodes the source video to output a bitstream.

In at least one implementation, the encoder module 1012 may receive a source video including a plurality of image frames, and then divide the image frames according to a coding structure. In at least one implementation, each of the image frames may be divided into at least one image block. The at least one image block may include a luminance block having a plurality of luminance samples, and at least one chrominance block having a plurality of chrominance samples. The luminance block and the at least one chrominance block may be further divided to generate macroblocks, coding tree units (CTUs), coding blocks (CBs), sub-divisions thereof, and/or another equivalent coding unit. In at least one implementation, the encoder module 1012 may perform additional sub-divisions of the source video. It should be noted that the present disclosures described herein are generally applicable to video coding, regardless of how the source video is partitioned prior to and/or during encoding.

In at least one implementation, during the encoding process, the prediction process unit 10121 receives a current image block of a specific one of the image frames. The current image block may be one of the luminance block and the at least one of the chrominance block in the specific image frame. The partition unit 101211 may divide the current image block into multiple block units. The intra prediction unit 101212 may perform intra-predictive coding of a current block unit relative to one or more neighboring blocks in the same frame as the current block unit to provide spatial prediction. The inter prediction unit 101213 may perform inter-predictive coding of the current block unit relative to one or more blocks in one or more reference image blocks to provide temporal prediction.

In at least one implementation, the prediction process unit 10121 may select one of the coding results generated by the intra prediction unit 101212 and the inter prediction unit 101213 based on a mode selection method, such as a cost function. In at least one implementation, the mode selection method may be a rate-distortion optimization (RDO) process. The prediction process unit 10121 may determine the selected coding result, and provide a predicted block corresponding to the selected coding result to the first summer 10122 for generating a residual block and to the second summer 10125 for reconstructing the encoded block unit. In at least one implementation, the prediction process unit 10121 may further provide syntax elements, such as motion vectors, intra-mode indicators, partition information, and other syntax information, to the entropy encoding unit 10128.

In at least one implementation, the intra prediction unit 101212 may intra-predict the current block unit. In at least one implementation, the intra prediction unit 101212 may determine an intra-prediction mode directing toward reconstructed sample neighboring the current block unit to encode the current block unit. In at least one implementation, the intra prediction unit 101212 may encode the current block unit using various intra-prediction modes, and the intra prediction unit 101212 or the prediction process unit 10121 may select an appropriate intra-prediction mode from the tested modes. In at least one implementation, the intra prediction unit 101212 may encode the current block unit using a cross component prediction mode to predict one of the two chroma components of the current block unit based on the luma components of the current block unit. In addition, the intra prediction unit 101212 may predict a first one of the two chroma components of the current block unit based on the other of the two chroma components of the current block unit.

In at least one implementation, the inter prediction unit 101213 may inter-predict the current block unit as an alternative to the intra-prediction performed by the intra prediction unit 101212, as described above. The inter prediction unit 101213 may perform a motion estimation to estimate a motion of the current block unit for generating a motion vector. The motion vector may indicate a displacement of the current block unit within the current image block relative to a reference block unit within a reference image block. In at least one implementation, the inter prediction unit 101213 receives at least one reference image block stored in the decoded picture buffer 10127 and estimates the motion based on the received reference image blocks to generate the motion vector.

In at least one implementation, the first summer 10122 generates the residual block by subtracting the prediction block determined by the prediction process unit 10121 from the original current block unit. The first summer 10122 represents the component or components that perform this subtraction operation.

In at least one implementation, the transform/quantization unit 10123 applies a transform to the residual block to generate a residual transform coefficient, and then quantizes the residual transform coefficients to further reduce bit rate. In at least one implementation, the transform may be DCT, DST, AMT, MDNSST, HyGT, signal dependent transform, KLT, wavelet transform, integer transform, sub-band transform or a conceptually similar transform. In at least one implementation, the transform may convert the residual information from a pixel value domain to a transform domain, such as a frequency domain. In at least one implementation, the degree of quantization may be modified by adjusting a quantization parameter. In at least one implementation, the transform/quantization unit 10123 may perform a scan of the matrix including the quantized transform coefficients. Alternatively, the entropy encoding unit 10128 may perform the scan.

In at least one implementation, the entropy encoding unit 10128 may receive a plurality of syntax elements including quantization parameter, transform data, motion vectors, intra modes, partition information, and other syntax information, from the prediction process unit 10121, and the transform/quantization unit 10123, and encode encodes the syntax elements into the bitstream. In at least one implementation, the entropy encoding unit 10128 entropy encodes the quantized transform coefficients. In at least one implementation, the entropy encoding unit 10128 may perform CAVLC, CABAC, SBAC, PIPE coding or another entropy coding technique to generate an encoded bitstream. In at least one implementation, the encoded bitstream may be transmitted to another device (e.g., the destination device 12) or archived for later transmission or retrieval.

In at least one implementation, the inverse quantization/inverse transform unit 10124 may apply inverse quantization and inverse transformation to reconstruct the residual block in the pixel domain for later use as a reference block. In at least one implementation, the second summer 10125 adds the reconstructed residual block to the prediction block provided from the prediction process unit 10121 to produce a reconstructed block for storage in the decoded picture buffer 10127.

In at least one implementation, the filtering unit 10126 may include a deblocking filter, a SAO filter, a bilateral filter, and/or an ALF to remove blockiness artifacts from the reconstructed block. Additional filters (in loop or post loop) may also be used in addition to the deblocking filter, the SAO filter, the bilateral filter and the ALF. Such filters are not shown for brevity, but if desired, may filter the output of the second summer 10125.

In at least one implementation, the decoded picture buffer 10127 may be a reference picture memory that stores the reference block for use in encoding video by the encoder module 1012, e.g., in intra- or inter-coding modes. The decoded picture buffer 10127 may be formed by any of a variety of memory devices, such as DRAM, including SDRAM, MRAM, RRAM), or other types of memory devices. In at least one implementation, the decoded picture buffer 10127 may be on-chip with other components of the encoder module 1012, or off-chip relative to those components.

In at least one implementation, the encoder module 1012 may perform the prediction method for predicting a plurality of sub-block units based on different reference samples according to the same prediction mode as shown in FIG. 3. The method in FIG. 3 may be carried out using the configurations illustrated in FIG. 1 and FIG. 10, for example, and various elements of these figures are referenced in explaining the example method. Furthermore, the order of blocks in FIG. 3 is illustrative only and may change. Additional blocks may be added or less blocks may be utilized without departing from this disclosure.

At block 31, the encoder module 1012 determines a block unit from an image frame according to video data.

In at least one implementation, the video data may be a video. The source device 11 may receive the video by the source module 111. The encoder module 1012 may determine the image frame from the video and divide the image frame to determine the block unit.

In at least one implementation, the prediction process unit 1021 of the source device 11 may determine the block unit from the video via the partition unit 101211, and then the encoder module 1012 may provide a plurality of partition indications into a bitstream based on a partition result of the partition unit 101211.

At block 32, the prediction process unit 10121 determines a sub-partition direction of the block unit from a plurality of candidate directions and a prediction mode of the block unit from a plurality of candidate modes according to the video data.

In at least one implementation, the prediction process unit 10121 of the destination device 12 may select the sub-partition direction from the candidate directions. In at least one implementation, the candidate directions may include a horizontal direction and a vertical direction. In at least one implementation, the candidate directions may include a cross direction having the horizontal direction and the vertical direction.

In at least one implementation, the candidate modes may be selected from a plurality of intra prediction modes including a plurality of angular modes, and a plurality of non-angular modes. In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 33, the prediction process unit 10121 partitions the block unit along the sub-partition direction to generate a plurality of sub-block units.

In at least one implementation, the number of the sub-block units may be equal to two, when the sub-partition direction is one of the horizontal direction and the vertical direction. In at least one implementation, the number of the sub-block units may be equal to four, when the sub-partition direction is the cross direction.

In at least one implementation, the block unit may be equally divided along the sub-partition direction to generate the sub-block units having equal sizes. In at least one implementation, the block unit may be unequally divided along the sub-partition direction to generate the sub-block units having unequal sizes.

At block 34, the intra prediction unit 101212 determines a sample set including a plurality of reference samples for each of the sub-block units.

In at least one implementation, the intra prediction unit 101212 may select a plurality of neighboring samples of a specific one of the sub-block units as the reference samples and add the reference samples of the specific sub-block unit to a specific one of the sample sets.

In at least one implementation, the neighboring samples may be selected from a plurality of neighboring blocks of the block unit and the sub-block units.

At block 35, the encoder module 1012 reconstructs each of the sub-block units based on a corresponding one of the sample sets according to the prediction mode of the block unit.

In at least one implementation, the block unit may include a plurality of block elements. In the implementation, each of the block elements may be a pixel element. In at least one implementation, the prediction process unit 10121 may generate a plurality of first predicted components for each of the sub-block units based on the corresponding one of the sample sets according to the prediction mode of the block unit. In at least one implementation, the first predicted components may be adjusted based on a plurality of adjusting samples and a plurality of weighting parameters to generate a plurality of second predicted components for each of the sub-block units. In at least one embodiment, the adjusting samples for a specific one of the first predicted components may be selected from the sample sets in a specific one of the sub-block units having the specific one of the first predicted components based on a sub-block size of the specific sub-block unit and a component location of the specific one of the first predicted components. In at least one implementation, the number of the weighting parameters for each of the sub-block units may be determined based on a sub-block location for each of the sub-block units.

In the implementation, each of the first predicted components in the sub-block units corresponds to one of the block elements, and each of the second predicted components in the sub-block units corresponds to one of the block elements. In at least one implementation, the encoder module 1012 may predict the block unit to generate a plurality of residual samples based on the first predicted components. In at least one implementation, the encoder module 1012 may predict the block unit to generate the residual samples based on the second predicted components. In at least one implementation, the encoder module 1012 may provide the bitstream including a plurality of coefficients corresponding to the residual samples. In addition, the encoder module 1012 may return the residual samples based on the coefficients and add the returned residual samples to one of the first predicted components and the second predicted components to generate a plurality of reconstructed components for reconstructing the block unit.

In at least one implementation, the intra prediction unit 101212 may predicts the block unit according to all other prediction modes to generate a plurality of predicted results. In at least one implementation, the prediction process unit 10121 may select one of predicted results based on a mode selection method, such as a cost function. In at least one implementation, the mode selection method may be a rate-distortion optimization (RDO) process. In at least one implementation, the prediction process unit 10121 may generate the residual samples based on the first predicted components for the block unit, when the selected predicted results correspond to the determined prediction mode for generating the first predicted components. In at least one implementation, the prediction process unit 10121 may generate the residual samples based on the second predicted components for the block unit, when the selected predicted results correspond to the determined prediction mode for generating the second predicted components.

In at least one implementation, the encoder module 1012 may perform the adjustment method for adjusting a predicted result based on a block size as shown in FIG. 9. The method in FIG. 3 may be carried out using the configurations illustrated in FIG. 1 and FIG. 10, for example, and various elements of these figures are referenced in explaining the example method. Furthermore, the order of blocks in FIG. 9 is illustrative only and may change. Additional blocks may be added or less blocks may be utilized without departing from this disclosure.

At block 91, the encoder module 1012 determines a block unit including a plurality of block components from an image frame according to video data.

In at least one implementation, the video data may be a video. The source device 11 may receive the video by the source module 111. The encoder module 1012 may determine the image frame from the video and divide the image frame to determine the block unit.

In at least one implementation, the prediction process unit 1021 of the source device 11 may determine the block unit from the video via the partition unit 101211, and then the encoder module 1012 may provide a plurality of partition indications into a bitstream based on a partition result of the partition unit 101211.

At block 92, the prediction process unit 10121 determines a prediction mode of the block unit from a plurality of candidate modes according to the video data.

In at least one implementation, the candidate modes may include a DC mode, a Planar mode, a horizontal mode and a vertical mode. In at least one implementation, the candidate modes may include the DC mode, the Planar mode, the horizontal mode, the vertical mode, a bottom-left angular mode, a top-right angular mode, Nm first non-diagonal angular modes neighboring the top-right angular mode and Nm second non-diagonal angular modes neighboring the bottom-left angular mode. In at least one implementation, the candidate modes may be a plurality of most probable modes derived based on a plurality of neighboring modes. In at least one implementation, a plurality of neighboring blocks adjacent to the block unit may be predicted in the neighboring modes selected from the intra prediction modes.

At block 93, the intra prediction unit 101212 determines a plurality of reference samples of the block unit and determine a plurality of first predicted components based on the reference samples according to the prediction mode for the block components.

In at least one implementation, the intra prediction unit 101212 may select a plurality of neighboring samples in a plurality of neighboring blocks of the block unit as the reference samples. In at least one implementation, the intra prediction unit 101212 may determine the first predicted components based on the reference samples according to the selected intra prediction mode.

At block 94, the intra prediction unit 101212 determines, for each of the block components, a plurality of adjusting samples from the reference samples based on a block size of the block unit and a component location of a corresponding one of the block components.

In at least one implementation, the intra prediction unit 101212 may determine a specific one of the component locations for a specific one of the block components, when the intra prediction unit 101212 determines the adjusting samples for the specific block components. In at least one implementation, the intra prediction unit 101212 determine the adjusting samples for the specific block components in the block unit based on the block size of the block unit, the specific component location (x, y) and a predefined sample location. In at least one implementation. Ns of the adjusting samples S_{(-1, -1)}, S_{(x, -1)}, S_{(-1, y)}, S_{([x/2]-1, -1)}, S_{(-1, [y/2]-1)}, S_{([W/2]-1, -1)}, S_{(-1, [H/2]-1)}, S_{(x+[(W-x)/2]-1, -1)}, and S_{(-1, y+[(H-y)/2]-1)} may be selected, when the specific component location is (x, y) and the block size is W×H. In at least one, implementation, some of the adjusting samples may overlap each other. In at least one implementation, one of the overlapped adjusting samples may remain in the adjusted samples, and the other overlapped adjusted samples may be omitted. In at least one implementation, each of the overlapped adjusting samples may remain in the adjusting samples.

In at least one implementation, the reference samples of the block unit may be further divided to generate a plurality of sample regions. In at least one implementation, the intra prediction unit 101212 may select Na, Nb, . . . , and Nn reference samples from the sample regions, and add the selected reference samples to the adjusting samples. In at least one implementation, each of the numbers Na, Nb, . . . , and Nn may be a predefined integer greater than or equal to zero, and may be different from, or equal to, each other.

At block 95, the intra prediction unit 101212 adjusts each of the first predicted components based on the adjusting samples of a corresponding one of the block components and a plurality of weighting parameters to generate a second predicted block.

In at least one implementation, a specific one of the first predicted components and the adjusting samples corresponding to the specific one of the first predicted components may be combined with the weighting parameters to generate a corresponding one of the second predicted components. In at least one implementation, the number of the weighting parameters may be equal to Ns+1, when the number of the adjusting samples is equal to Ns.

At block 96, the encoder module 1012 reconstructs the block unit based on the second predicted components.

In at least one implementation, the block unit may include a plurality of block elements. In the implementation, each of the block elements may be a pixel element. In the implementation, each of the second predicted components in the block unit corresponds to one of the block elements. In at least one implementation, the encoder module 1012 predicts the block unit to generate a plurality of residual samples based on the predicted components and provide the bitstream including a plurality of coefficients corresponding to the residual samples. In addition, the encoder module 1012 may return the residual samples based on the coefficients and add the returned residual samples to the predicted components to generate a plurality of reconstructed components for reconstructing the block unit.

In at least one implementation, the intra prediction unit 101212 may predicts the block unit according to all other prediction modes to generate a plurality of predicted results. In at least one implementation, the prediction process unit 10121 may select one of predicted results based on a mode selection method, such as a cost function. In at least one implementation, the mode selection method may be a rate-distortion optimization (RDO) process. In at least one implementation, the prediction process unit 10121 may generate the residual samples based on the second predicted block for the block unit, when the selected predicted results correspond to the determined prediction mode for generating the second predicted block.

From the above description, it is manifest that various techniques may be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of decoding a bitstream by an electronic device, the method comprising:
determining a block unit from an image frame according to the bitstream;
determining a sub-partition direction of the block unit from a plurality of candidate directions, and a prediction mode of the block unit from a plurality of candidate modes according to the bitstream;
partitioning the block unit along the sub-partition direction to generate a plurality of sub-block units;
determining a sample set including a plurality of reference samples for each of the sub-block units, wherein the sample sets of the sub-block units are different from each other; and
reconstructing each of the plurality of sub-block units based on a corresponding one of the sample sets according to the prediction mode of the block unit.

2. The method according to claim 1, wherein the plurality of candidate directions includes a horizontal direction and a vertical direction.

3. The method according to claim 2, wherein a block height of the block unit is equally divided into a plurality of sub-block heights of the plurality of sub-block units when the sub-partition direction is the horizontal direction.

4. The method according to claim 2, wherein a block width of the block unit is equally divided into a plurality of sub-block widths of the plurality of sub-block units when the sub-partition direction is the vertical direction.

5. The method according to claim 1, wherein the plurality of candidate modes includes a DC mode, a Planar, an intra vertical mode, and an intra horizontal mode determined from a plurality of intra prediction modes.

6. The method according to claim 1, wherein a specific one of the sample sets corresponding to a specific one of the sub-block units includes a plurality of neighboring samples neighboring the specific sub-block unit, when the specific sub-block unit is reconstructed based on the prediction mode of the block unit.

7. The method according to claim 6, wherein the plurality of reference samples in the specific sample set is selected from one or more other sub-block units neighboring the specific sub-block unit and a plurality of neighboring blocks of the block unit, when the specific sub-block unit is reconstructed after reconstructing the one or more other sub-block units.

8. The method according to claim 6, further comprising:
determining a first predicted block according to the prediction mode of the block unit for the specific sub-block unit;
determining the plurality of reference samples of the specific sub-block unit;
adjusting the first predicted block based on the plurality of reference samples of the specific sub-block unit; and a plurality of weighting parameters to generate a second predicted block corresponding to the specific sub-block unit; and
reconstructing the block unit based on the second predicted block and a residual block corresponding to the specific sub-block unit and determined from the bitstream.

9. An electronic device for decoding a bitstream, the electronic device comprising:
at least one processor; and
a storage device coupled to the at least one processor and storing a plurality of instructions which, when executed by the at least one processor, causes the at least one processor to:
determine a block unit from an image frame according to the bitstream;
determine a sub-partition direction of the block unit from a plurality of candidate directions, and a prediction mode of the block unit from a plurality of candidate modes according to the bitstream;
partition the block unit along the sub-partition direction to generate a plurality of sub-block units;
determine a sample set including a plurality of reference samples for each of the sub-block units, wherein the sample sets of the sub-block units are different from each other; and
reconstruct each of the plurality of sub-block units based on a corresponding one of the sample sets according to the prediction mode of the block unit.

10. The electronic device according to claim 9, wherein the plurality of candidate directions includes a horizontal direction and a vertical direction.

11. The electronic device according to claim 10, wherein a block height of the block unit is equally divided into a plurality of sub-block heights of the plurality of sub-block units during partitioning along the horizontal direction, and a block width of the block unit is equally divided into a plurality of sub-block widths of the plurality of sub-block units during partitioning along the vertical direction.

12. The electronic device according to claim 9, wherein the plurality of candidate modes includes a DC mode, a Planar, an intra vertical mode, and an intra horizontal mode determined from a plurality of intra prediction modes.

13. The electronic device according to claim 9, wherein a specific one of the sample sets corresponding to a specific one of the sub-block units includes a plurality of neighboring samples neighboring the specific sub-block unit, when the specific sub-block unit is reconstructed based on the prediction mode of the block unit.

14. The electronic device according to claim 13, wherein a first predicted block is determined according to the prediction mode for the specific sub-block unit, and adjusted based on a plurality of weighting parameters and the plurality of reference samples neighboring the specific sub-block unit to generate a second predicted block for the specific sub-block unit to reconstruct the block unit.

15. A method of decoding a bitstream by an electronic device, the method comprising:
determining a block unit from an image frame according to the bitstream;
determining a prediction mode of the block unit from a plurality of candidate modes according to the bitstream;
partitioning the block unit equally to generate a plurality of sub-block units each having a sub-block size, wherein the sub-block sizes of the plurality of the sub-block units are identical to each other;
determining a sample set including a plurality of reference samples for each of the sub-block units, wherein the sample sets of the sub-block units are different from each other; and
reconstructing each of the plurality of sub-block units based on a corresponding one of the sample sets according to the prediction mode of the block unit.

16. The method according to claim 15, wherein the block unit is equally partitioned along a sub-partition direction selected from a plurality of candidate directions including a horizontal direction and a vertical direction.

17. The method according to claim 16, wherein the block unit has a block size including a block width and a block height, and one of the block width and the block height is selected, according to the sub-partition direction, to be equally divided.

18. The method according to claim 15, wherein the plurality of candidate modes includes a DC mode, a Planar, an intra vertical mode, and an intra horizontal mode determined from a plurality of intra prediction modes.

19. The method according to claim 15, wherein a specific one of the sample sets corresponding to a specific one of the sub-block units includes a plurality of neighboring samples neighboring the specific sub-block unit, when the specific sub-block unit is reconstructed based on the prediction mode of the block unit.

20. The method according to claim 19, wherein the plurality of reference samples in the specific sample set is selected from one or more other sub-block units neighboring the specific sub-block unit and a plurality of neighboring blocks of the block unit, when the specific sub-block unit is reconstructed after reconstructing the one or more other sub-block units.
